(19) United States
(12) Patent Application Publication
(10) Pub. No.: US 2005/0201711 A1
(43) Pub. Date: Sep. 15, 2005

(54) Packaging and interconnect system for fiber and optoelectric components

(76) Inventors: Philip Joseph Koh, Centreville, VA (US); Steven Michael Marazita, Charlottesville, VA (US); David Thompson Nemeth, Washington, DC (US)

Correspondence Address: SUGHRUE MION, PLLC, 2100 PENNSYLVANIA AVENUE, N.W., SUITE 800, WASHINGTON, DC, 20037, US

(21) Appl. No.: 10/466,818

(22) PCT Filed: Jan. 22, 2002
(86) PCT No.: PCT/US02/01510

§ 371 Date: Nov. 5, 2003

(30) Foreign Application Priority Data
Jan. 22, 2001 (US) 60262907
Aug. 28, 2001 (US) 60315443

(51) Int. Cl. G02B 6/36

(52) U.S. Cl. 385/137; 385/88

(57) ABSTRACT

A packaging system for optical or optoelectronic devices having a first package of micromachined material having at least one male connection component and a second package of micromachined material having at least one female component, wherein the male connection component is configured to mate with the female connection component. A mating surface of the male component and the female component has V-grooves designed to accept a first optical fiber and a second optical fiber, wherein the first V-groove (3) is configured to align with the second V-groove (6) when the first package and second package mate, thereby passively aligning the first optical fiber (4) with the second optical fiber (8) to form a high quality fiber butt joint. Alternatively, the female component is configured to accept a photodetector, wherein the first V-groove and second V-groove passively align the first optical fiber with the photodetector.

### RELATED APPLICATIONS

The present application claims priority from the co-pending U.S. Provisional Patent Application Ser. No. 60/262,907 filed Jan. 22, 2001, and provisional Patent Application Ser. No. 60/315,443 filed Aug. 28, 2001, the disclosures of which are incorporated herein by reference.

### BACKGROUND OF THE INVENTION

The present invention relates to a packaging system for optical and optoelectronic devices, more particularly, to a packaging system for connecting optical fibers to each other or for connecting optical fibers to an electrical converter, and even more particularly to a micromachined plug and socket apparatus that uses V-grooves to passively align optical fibers to each other, or optical fibers to an electrical converter.

Conventional optical fiber to electrical converters require active alignment techniques. Similarly, conventional optical fiber to optical fiber connections also require active alignment techniques. Conventional methods of connecting optical fibers, or optical fibers to an electrical converter, require a skilled laborer to manually align the optical fibers together, or to manually align the optical fiber to an electrical converter. For example, first, the skilled laborer must manually move the optical fiber into position. Next, the skilled laborer must perform a test to determine if an acceptable response is achieved based on the position of the optical fiber. If the response is not acceptable, the skilled laborer must reposition the optical fiber and perform another test to determine if an acceptable response is achieved based on the repositioning. This process must be repeated until an acceptable response is achieved. Once an acceptable signal has been achieved, the position of the optical fiber in relation to the electrical converter must be fixed by applying an adhesive. Further, the position of the optical fiber in relation to the electrical converter must be maintained until the adhesive sets or hardens. This adhesive can expand or contract with temperature, moving the fiber out of alignment with the second fiber or electrical converter. This process of active alignment is very time consuming and cost inefficient. In addition, the requirement of skilled labor to align the optical fiber to the electrical converter prohibits end users from attaching and reattaching the optical fibers, or the optical fiber to the electrical converter, without the expertise of a skilled laborer. For example, connecting and disconnecting fibers requires a time-consuming fiber splicing procedure every time the module needs to be disconnected and reconnected. Further, the final assembly of the optical fiber to the electrical converter is limited to individual skilled laborers experienced in attaching the optical fibers to electrical converters and prohibits the delegation of the assembly of these components to other non-skilled laborers. Alternatively, it is known to use machines to position the optical fiber; however, even if machines are used, active testing is still required to verify that the signal achieved is acceptable. As with manual positioning of the optical fiber, if the signal achieved is unacceptable, the machine must reposition the fiber and perform another test to determine if the signal is acceptable. This process is repeated until an acceptable signal is achieved. The position of the optical fiber is then fixed using an adhesive.

FIG. 1 depicts an example of a conventional fiber to photodetector device produced by Haleos, Inc. The silicon optical bench (SiOB) depicted in FIG. 1 is used for fiber to photodetector alignment and integration with other electrical components. As shown in FIG. 1, the known silicon optical bench 95 uses a V-Groove 92 to align the optical fiber 91 with a ball lens 93. The ball lens 93 is positioned in a notch 96 between the V-groove 92 and the photodetector 94. However, known fiber to fiber, or fiber to electrical converter devices are not capable of being plugged and unplugged, at either the fiber end of the device or the electrical end of the device, to provide modularity or upgradeability. In addition, conventional fiber to fiber and fiber to electrical converter devices require additional external environmental protection because of their open-top design. Conventional packaging systems use butterfly packages.

A conventional butterfly package is shown in FIG. 2. These butterfly packages have bulky metal housings 80 with DC feedthroughs 81 on either side. The DC feedthroughs are inserted in holes 82 having hermetic seals 83. In addition, conventional butterfly housings include connectors 84 on either side of the housing 80 for fiber in and electrical out, electrical in and electrical out, or fiber in and fiber out applications. Conventional butterfly packages mount discrete devices, such as a silicon optical bench as shown in FIG. 1, inside the housing 80 for connecting optical fibers to each other, or for connecting an optical fiber to an electrical converter. The DC feedthroughs are wire or ribbon bonded to the discrete device within the housing 80. Further, conventional butterfly packages typically include a separate heatsink (not shown) mounted in the housing 80, as well as other discrete components. The housing 80 further includes a lid (not shown) sealed to the top of the housing 80 with solder, or a hermetic seal.

However, because of the need to use a housing to encapsulate the discrete devices, conventional butterfly packages suffer from increased size and weight. In addition, the conventional butterfly packages require extended assembly and prototyping time, thereby increasing manufacturing costs. The ability to rework, repair, or upgrade modules is not possible using the conventional approach and therefore long term total cost of ownership is also high.

### SUMMARY OF THE INVENTION

It is therefore an object of this invention to provide a packaging system for optical and optoelectronic devices for connecting optical fibers to each other or for connecting optical fibers to an electrical converter.

It is therefore another object of the present invention to eliminate the need for costly active alignment of fiber to fiber and fiber to electrical connections in the manufacturing process for optical and optoelectronic modules.

It is a further object of the present invention to provide a micromachined plug and socket apparatus that uses V-grooves to passively align optical fibers to each other, or optical fibers to an electrical converter to greatly simplify the connection. For example, each socket and plug in the apparatus can have one or multiple V-grooves etched in them with fibers positioned in each V-groove.

It is therefore another object of the present invention to provide a serial connection between one set of fibers and another set of fibers by simply sliding the plug into the socket.

In particular, it is an object of the present invention to provide a high quality fiber butt joint using V-groove alignment with a plug and socket connector to precisely slide the fibers into alignment with each other.

It is another object of the present invention to provide an apparatus for connecting a plurality of optical fibers, or an optical fiber to an electrical converter, in which un-mating or disconnecting the connectors is as simple as connecting the connectors.

It is yet another object of the invention to greatly lower the cost of installing, maintaining, and troubleshooting optical distribution systems.

It is a further object of the invention to provide an apparatus for connecting a plurality of optical fibers, or an optical fiber to an electrical converter, that improves flexibility and system prototyping to greatly reduce design cycle times and therefore overall system costs.

It is yet another object of the invention to provide integrated, prepackaged optical transmitters/modulators and detectors.

It is a further object of the present invention to provide an apparatus for connecting a plurality of optical fibers, or an optical fiber to an electrical converter, where different optical and electrical modules can be connected together during system prototyping, or even in the field, to greatly lower system costs, for example, by reducing component costs, assembly complexity, design cycles, and prototyping moderations.

It is still another object of the present invention to form a two-dimensional array of optical and electrical components and stacking the two-dimensional arrays to form a highly compact three-dimensional system of optical and electrical components.

It is yet another object to the present invention to provide an apparatus for connecting a plurality of optical fibers, or an optical fiber to an electrical converter, where the optical fiber can be attached and detached from the electrical converter over and over, thereby providing a repeatable connection that provides ease of replacement, maintenance, prototyping, manufacturing, and upgrades to components with different specifications. In addition, it is an object of the present invention to provide an apparatus that permits reconfiguring both on a test bench and in the field.

It is another object of the present invention to provide an apparatus for connecting a plurality of optical fibers, or an optical fiber to an electrical converter, which can be optimized for low dispersion and low loss. Specifically, it is an object of the present invention to provide an apparatus for connecting a plurality of optical fibers, or an optical fiber to an electrical converter, that has a zero to minimum dispersion.

It is yet another object of the present invention to provide an apparatus for connecting an optical fiber to an electrical converter that is scalable to allow scaling down the device in order to push the operating frequency higher while maintaining minimal insertion loss, return loss, and group delay variation on the electrical side.

It is yet another object of the present invention to provide an apparatus for connecting a plurality of optical fibers that is scalable to allow different optical fiber cross sections to be used for different, shorter, or longer wavelength operation in addition to different optical fiber types, such as single-mode, multimode, and polarization maintaining varieties.

It is still another object of the present invention to provide an apparatus for connecting a plurality of optical fibers, or an optical fiber to an electrical converter, that is fully shielded to eliminate outside noise.

It is yet another object of the present invention to provide an apparatus for connecting optical fibers to an electrical converter that is backward compatible with industry standard butterfly packages.

It is another object of the present invention to provide an apparatus for connecting optical fibers to an electrical converter that is individually hermetically sealed to eliminate the need for butterfly packages or other environmental housings to surround and protect the optical or optoelectronic components.

It is yet another object of the present invention to provide an apparatus for connecting optical fibers to an electrical converter that is hermetically sealed by sealing the top of the packages with a soldered lid (hermetic).

It is still another object of the present invention to provide an apparatus for connecting optical fibers to an electrical converter that comprises a series of modular low footprint packages that can be plugged together, taken apart, changed around, and reconnected.

It is further object of the present invention to provide an apparatus for connecting optical fibers to an electrical converter or other fibers that distribute DC bias and signaling lines between modules, thereby eliminating the need for a butterfly package or similar industry standard housing.

It is yet another object of the present invention to provide an apparatus for connecting optical fibers to an electrical converter that decreases the size, weight, assembly time, and prototyping time, thereby reducing manufacturing costs.

Further objects, features and advantages of the invention will become apparent from the consideration of the following description and the appended claims when taken in connection with the accompanying drawings.

### BRIEF DESCRIPTION OF THE DRAWINGS

The above aspects of the present invention will become more apparent by describing in detail embodiments thereof with reference to the attached drawings in which:

FIG. 1 is a perspective view of a conventional silicon optical bench for optical fiber to photodetector alignment.

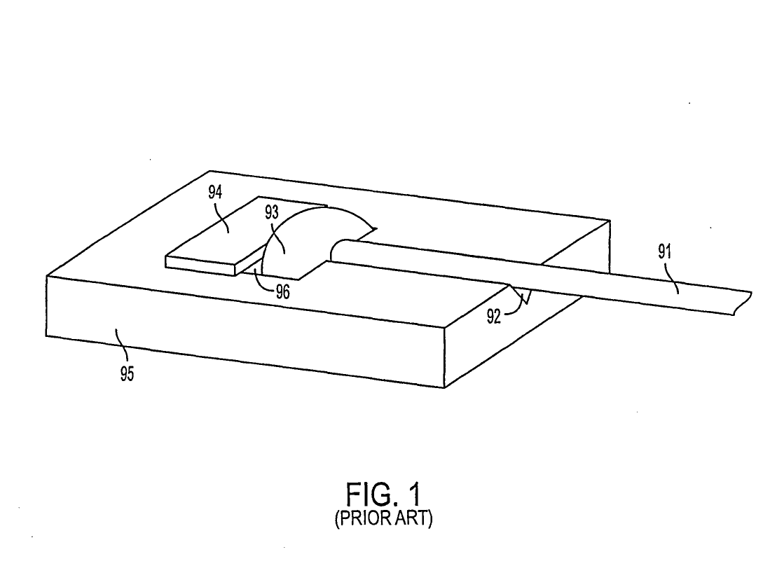

FIG. 2 is a perspective view of a conventional butterfly package used for environmental protection and mounting discrete components into an optical or optoelectronic module.

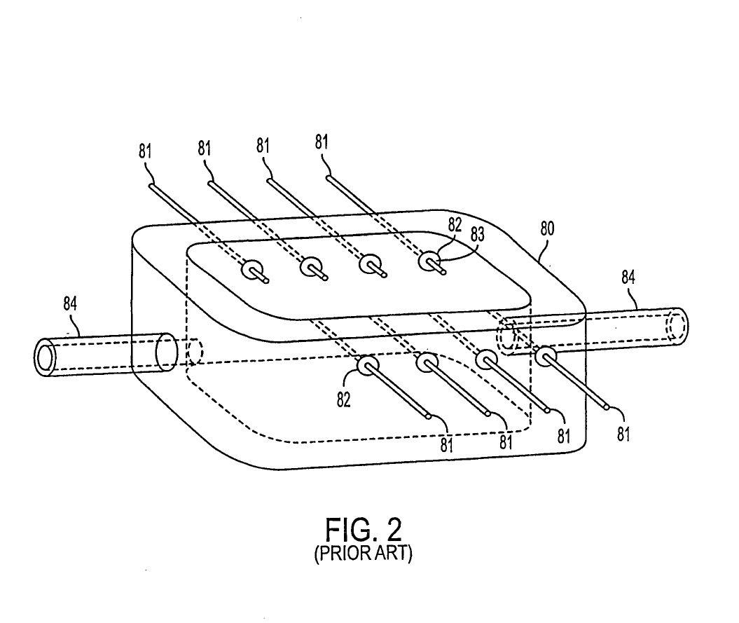

FIG. 3 is a perspective view depicting a micromachined plug and socket packaging system for forming an optical fiber butt joint using V-groove technology to align the fibers, according to a non-limiting embodiment of the present invention.

FIG. 4 is a perspective view depicting a micromachined plug and socket packaging system for forming an optical fiber butt joint, according to a non-limiting embodiment of the present invention.

FIG. 5 is a perspective view depicting a micromachined plug and socket packaging system for forming an optical fiber to electrical converter connection, according to another non-limiting embodiment of the present invention.

FIG. 6A is a perspective view of a micromachined plug and socket packaging system using micromachined V-grooves to provide impedance control and to minimize the loss and dispersion of the shielded plug to socket transmission line over wide bandwidths, according to a non-limiting embodiment of the present invention.

FIG. 6B is an assembled perspective view of a micromachined plug and socket packaging system using micromachined V-grooves to provide impedance control and to minimize the loss and dispersion of the shielded plug to socket transmission line over wide bandwidths, according to a non-limiting embodiment of the present invention.

FIG. 6C is a cross-sectional view of a micromachined plug and socket packaging system using V-grooves to provide impedance control and to minimize the loss and dispersion of the shielded plug to socket transmission line over wide bandwidths, according to a non-limiting embodiment of the present invention.

FIG. 7 depicts the insertion loss (dB) versus frequency (GHz) for a chip-to-chip connection through a plug and socket apparatus, according to a non-limiting embodiment of the present invention.

FIG. 8 depicts the return loss (dB) versus frequency (GHz) for a chip-to-chip connection through a plug and socket apparatus, according to a non-limiting embodiment of the present invention.

FIG. 9 depicts the time delay (pS) versus frequency (GHz) for a chip-to-chip connection through a plug and socket apparatus, according to a non-limiting embodiment of the present invention.

FIG. 10 depicts a system of modules according to a non-limiting embodiment of the present invention.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to one skilled in the art.

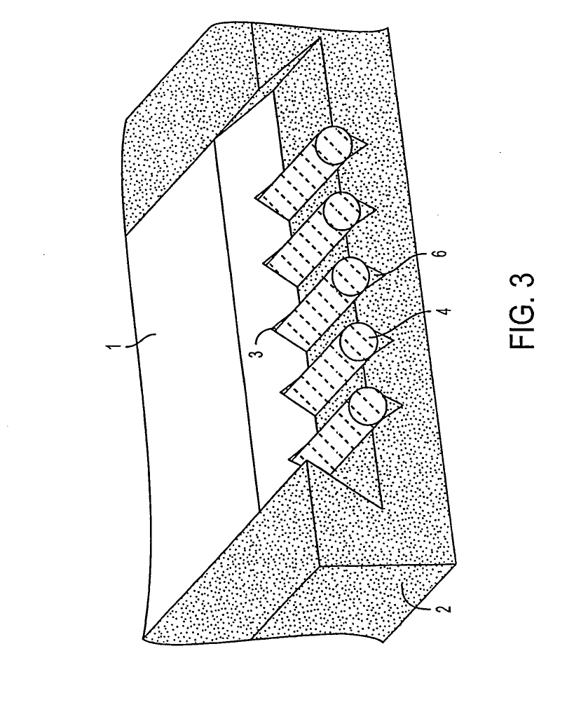

A non-limiting embodiment of a packaging system for optical and optoelectronic devices for connecting optical fibers to each other, or for connecting an optical fiber to an electrical converter, that solves the aforementioned problems, and others, is now described with reference to FIGS. 3-10.

FIG. 3 depicts a series of optical fibers aligned between two etched silicon V-grooves of a plug and socket packaging system. The plug and socket allow repeated assembly and disassembly of fiber array connections without the need for costly active alignment techniques or equipment. As shown in FIG. 3, the plug 1 mates with the socket 2. At least one V-groove 3, 6 is formed in the mating surfaces of the plug 1 and socket 2. Optical fibers 4 are positioned in the V-grooves 3, 6 of the plug 1 and socket 2, respectively. Optical fibers 4 are passively aligned by the corresponding shape of the V-grooves 3, 6 in the plug 1 and socket 2, respectively. The dimensions of the V-grooves 3, 6 can be designed to achieve the desired position of the optical fibers 4.

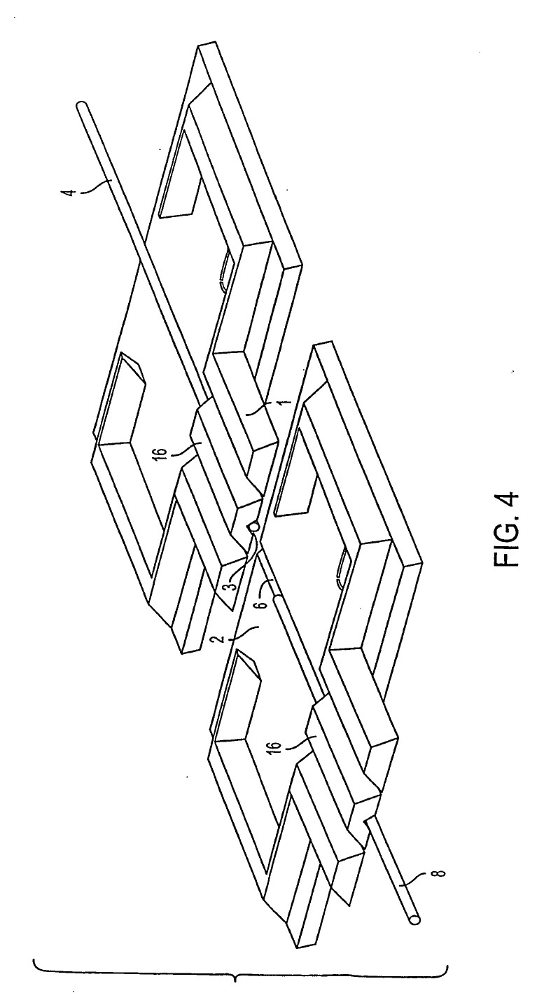

FIG. 4 depicts a perspective view of a non-limiting embodiment of a plug and socket optical fiber connector. As shown in FIG. 4, the optical fibers 4, 8 are positioned in the V-grooves 3, 6 of the corresponding plug 1 and socket 2. Each plug 1 and socket 2 in the system can have one or multiple V-grooves 3, 6 etched in them with fibers 4, 8 laying in each of the V-grooves 3, 6. By forming the plug and socket packaging system with the desired V-grooves 3, 6, the assembly of the apparatus requires simply sliding the plug 1 into the socket 2 to form a serial connection between the set of optical fibers 4, 8 positioned in the V-grooves 3, 6. A high quality butt joint is formed between the optical fibers 4, 8. No active or manual alignment of the optical fibers 4, 8 is necessary; rather, the optical fibers 4, 8 are passively aligned by the dimensions of the V-grooves 3, 6 so that when the plug 1 and socket 2 are connected, the optical fibers 4, 8 are aligned and butted together within the V-grooves 3, 6.

In addition, in other embodiments of the present invention, a ball lens can be passively positioned in a notch or groove between the optical fiber 4 and the optical fiber 8, for focusing the optical signal that is being transmitted between the optical fiber 4 and the optical fiber 8, to form a fiber butt joint.

Moreover, according to the present invention, assembly and disassembly of the apparatus can be repeatedly performed without having to test the apparatus for proper alignment. In addition, the un-mating or disconnecting of the plug and socket connectors according to the present invention can be performed as easily as connecting the plug and socket connectors, which greatly lowers the cost of installing, maintaining, and troubleshooting optical distribution systems.

The plug and socket packaging system of the present invention is preferably formed from silicon; however, other materials can be used for appropriate applications. In addition, in the preferred embodiment, the plug 1 and socket 2 each have an outer metal shield 16. Thus, when the plug 1 mates with the socket 2, the optical fibers 4, 8 and the interior of the package are completely encapsulated by not only the silicon plug 1 and socket 2, but also by an outer metal shield 16 and a soldered metal lid (not shown). Therefore, a fully-shielded connection within the plug/socket transition and entire packaged module is provided and outside noise or interference is minimized or eliminated.

Further, the plug and socket packaging system of the present invention preferably includes a hermetically sealed lid, such as a lid soldered over the package, or another means for hermetically sealing each individual package without requiring a butterfly package to provide external environmental protection. Therefore, the conventional butterfly package can be completely replaced by a plug and socket packaging system that is individually hermetically sealed. Alternatively, the plug and socket packaging system according to the present invention can be mounted inside a conventional butterfly package so that repair, replacement, or upgrade of modules within the butterfly package can be more efficiently performed, in comparison to conventional installed within the butterfly package.

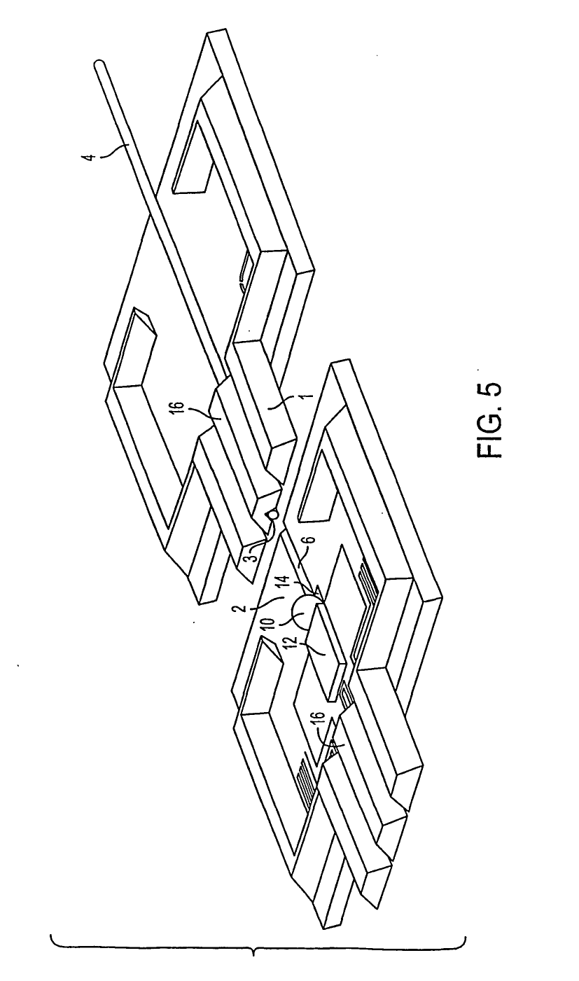

FIG. 5 depicts a perspective view of a non-limiting embodiment of an apparatus for connecting an optical fiber to an electrical converter. As shown in FIG. 5, socket 1 has a V-groove 3 in which an optical fiber 4 is passively positioned. In addition, socket 2 has a corresponding V-groove 6 positioned to accept the optical fiber 4 and aligned with the V-groove 3. In this embodiment, a PIN photo detector 12 is used to receive the signal from the optical fiber 4, however, other devices can be substituted for Pin photodetector, such as MSM photodetectors or optical modulator/detectors. The V-groove is designed so that by positioning the optical fiber in the V-grooves 3, 6, the optical fiber 4 is passively aligned with the sensor of the photodetector 12. The photodetector is surface mounted onto the package and is typically ribbon bonded to the electrical lines. In addition, the package can include an additional plug 11 (as shown in FIG. 5) or socket (not shown), for connecting the conductor lines to an additional package (not shown).

In addition, a ball lens 10 can also be used to focus the light from the optical fiber 4 to the sensor of the photo detector 12. It is important to align the ball lens with the optical fiber 4 in order to properly focus the signal from the optical fiber 4 to the photo detector 12 or optical modulator (not shown). As shown in FIG. 5, this is achieved by etching a cavity or notch 14 in the socket 2. This cavity or notch 14 is predetermined so that, upon assembly, the ball lens 10 is passively aligned with the optical fiber 4 and photodetector 12. This prevents misalignment of the ball lens with the optical fiber and eliminates the need to manually align the ball lens 10 with the optical fiber 4 and photo detector 12. The ball lens 10 is positioned in the cavity 14 and a glue or epoxy, or other adhesive is used to fix the ball lens 10 in the cavity 14.

In other embodiments, the plug 1 can include a corresponding V-groove or isotropically etched cavity that corresponds to the cavity or notch 14 in the socket 2 so that when the plug and socket are assembled, the opposing cavities or V-grooves hold the ball lens in place, thereby eliminating the need to use glue or epoxy. In addition, the lens is not limited to a ball lens; rather, other lens types can also be used. For example, a tubular or cylindrical lens can be used. The size and shape of the cavity 14 can be predetermined to passively align the cylindrical, or other shaped lens, with the optical fiber 4 and photodetector 12.

In the embodiment shown in FIG. 5, the photo detector 12 is mounted within the optoelectronic package which is electrically connected and integrally formed with the socket 2. The CPW lines from the socket run into the package interior and connect with the photodetector or modulator using ribbon bonds or surface mount technology. Other conductor lines, such as DC bias lines 24, can also be used or incorporated into the packaging system design. The socket 2 may further include an additional plug 11 or socket (not shown), so that the apparatus can be attached to an additional plug and socket apparatus to form a modular system.

The present invention is not limited to the placement of an optical fiber in a plug and an electrical converter in a socket; rather, either a plug or a socket, according to the present invention, is capable of holding either of these devices, or a combination of these or other devices.

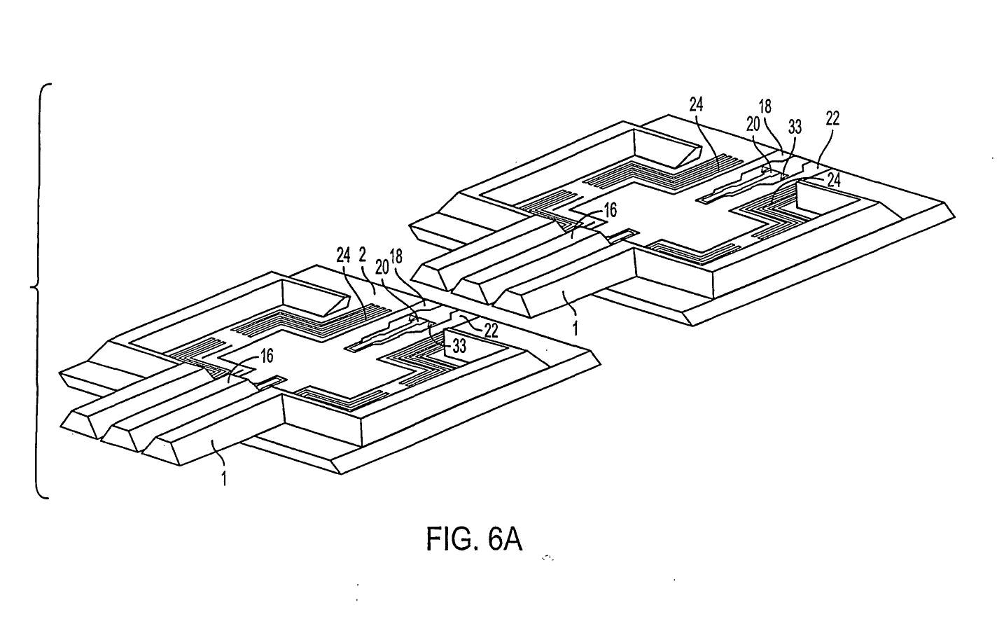

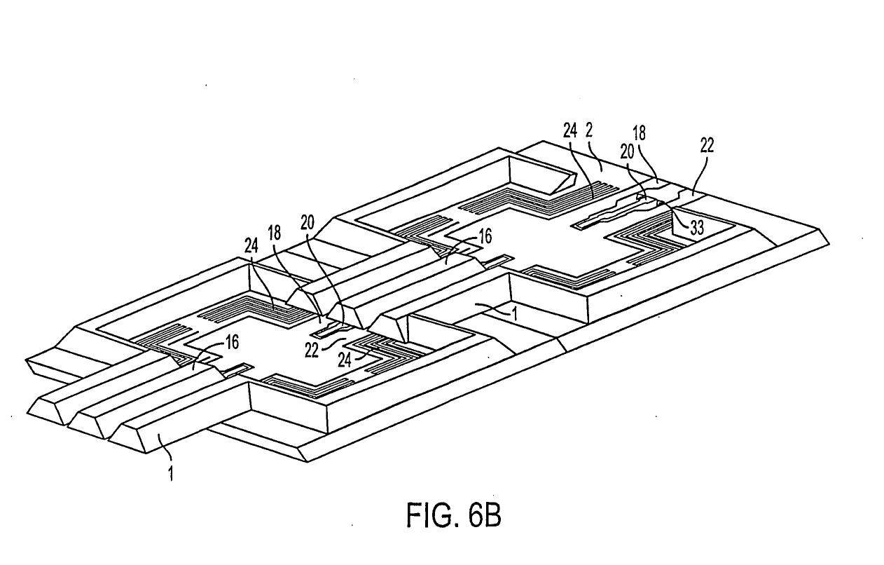

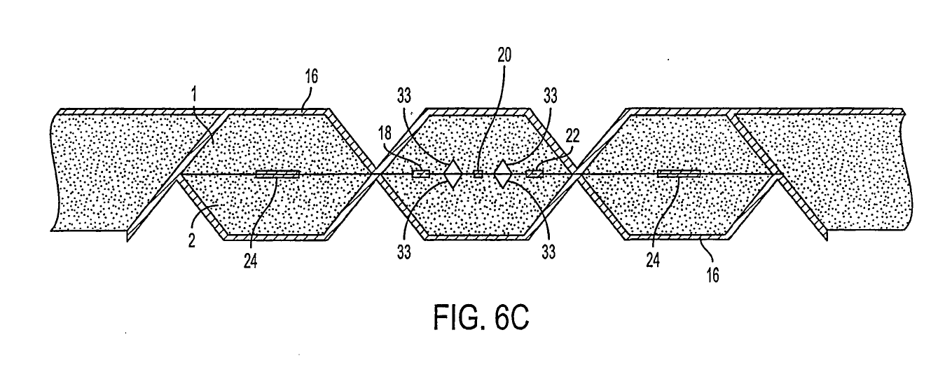

FIG. 6A depicts another non-limiting embodiment of a plug and socket connector, according to the present invention. As shown in FIG. 6A, plug 1 is divided into three sections, each in the shape of a half-hexagon. In addition, the socket 2 also comprises three sections, each in the shape of a half-hexagon, as shown in FIG. 6C. The silicon plug 1 mates with the socket 2, as shown in FIG. 6B. The plug 1 and socket 2 sections are formed in a mirror image so that when the plug 1 mates with the socket 2 the assembly forms a hexagon-shaped cross-section, thereby encapsulating the optical fiber or electrical conductor within the hexagon-shaped cross-section, as shown in FIG. 6C.

The present invention is not limited to plugs or sockets with only three sections. The plug 1 and socket 2 can be divided into less than or greater than three sections, depending on the application and the number of electrical connections desired. In addition, the plug 1 and socket 2 of the present invention are not limited to a hexagon-shape, and can be other shapes, for example, triangular in shape.

As shown in the non-limiting embodiment of FIGS. 6A-6C, the socket 2 includes conductor lines, for example, a center conductor 20 and ground planes 18 and 22. In addition, the socket 2 can also include DC bias lines 24 on either side of the conductor lines that mate with the additional hexagon-shaped sections of the plug 1.

In order to achieve lower loss and help lower dispersion, V-grooves 33 can be formed in the surface of the plug 1 and/or socket 2, thereby removing a portion of the silicon, or dielectric, to create air gaps. This provides the designer with the ability to vary the dimensions of the V-grooves 33, thereby permitting the designer to control or design the system for desired impedance. The V-grooves 33 form air gaps which provide a variable that the designer can adjust to lower loss. In addition, the designer can use this variable to control dispersion, i.e., to reduce time delay variation versus frequency. Further, the size of the air gaps can be varied to control impedance. More specifically, the ability to control the V-groove 33 size permits the apparatus to be designed to operate single-moded. For example, as the dielectric is removed, the designer can push the “turn on” frequency of the next mode to a higher frequency, so the device will stay in a single mode and behave more predictably with less chance for mode conversion or spurious radiation.

Furthermore, as shown in FIGS. 6A-6C, each of the plugs 1 has an outer metal shield 16. In addition, the outside surface of the socket 2 also has a metal shield 16. Thus, when the plug 1 mates with the socket 2, the assembly forms a hexagon-shaped cross-section that is completely surrounded by an outer metal shield 16, thereby encapsulating the optical fiber 4 or electrical conductors 18, 20, 22 within the hexagon-shaped cross-section, as shown in FIG. 6C, and providing a fully-shielded connection within the plug/socket transition. The packaging system according to the present invention minimizes or eliminates outside noise or interference.

In addition, as shown in FIG. 6C, the center conductor 20 and ground planes 18 and 22 can be formed on the mating surfaces of the plug 1 and socket 2 to provide a surface connection between the plug 1 and socket 2. In the present invention, multiple RF lines, such as 18, 20, and 22 can be positioned next to each other, each in a separate hexagon, but all within the same plug/socket transition. Since each RF line is shielded by the outer metal shield 16 of each hexagon, the RF lines can be densely packed together without crosstalk between them. Thus, each plug 1 and socket 2 is capable of carrying three or more RF lines running adjacent to one another. This is especially useful for arrays of electronic devices or in multiplexing (MUX) or demultiplexing (DEMUX) applications.

In an example of a non-limiting embodiment of the present invention, multiple optical fibers positioned in passive alignment V-grooves interface with individual PIN diodes. The individual PIN diodes receive the optical signal from the individual optical fibers and convert the signal to an electrical signal. Next, multiple 10 Gbit/sec electrical lines are multiplexed into one 40 Gbit/sec optical line. This process of taking parallel lines of optical signals and converting them into a single serial line is known as Multiplexing (MUX). On the other hand, the process of taking a single serial line and converting it into multiple parallel lines of optical signals is known as Demultiplexing (DEMUX). Thus, for example, four 10 Gbit/sec optical signals can be combined into one 40 Gbit/sec electrical signal. Conversely, for example, four 10 Gbit/sec electrical signals can be combined into one 40 Gbit/sec optical signal. According to the present invention, one package can perform a 1:4 or 4:1 conversion. Other conversions, such as 16:1, 1:16 can also be performed by one package according to the present invention.

The present invention is not limited to RF lines, such as the center conductor and ground planes depicted in FIGS. 6A-6C. For example, DC bias lines 24, which are also shown in FIGS. 6A and 6B, can be formed on the surfaces of the plug 1 and socket 2 to provide an electrical connection. In addition, other forms of electrical connections can be formed on the surfaces of the plug 1 and socket 2, or positioned within the plug 1 and socket 2.

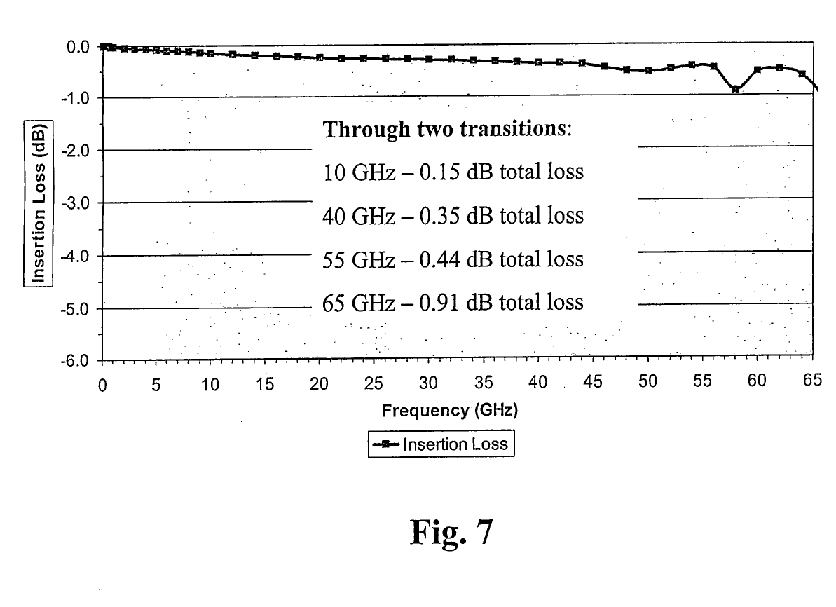

FIG. 6 shows a graph depicting the insertion loss (dB) versus frequency (GHz) for chip-to-chip connection through a plug and socket apparatus, according to the present invention. As shown in FIG. 7, the insertion loss can be minimized throughout a wide range of frequencies by using the plug and socket system according to the present invention.

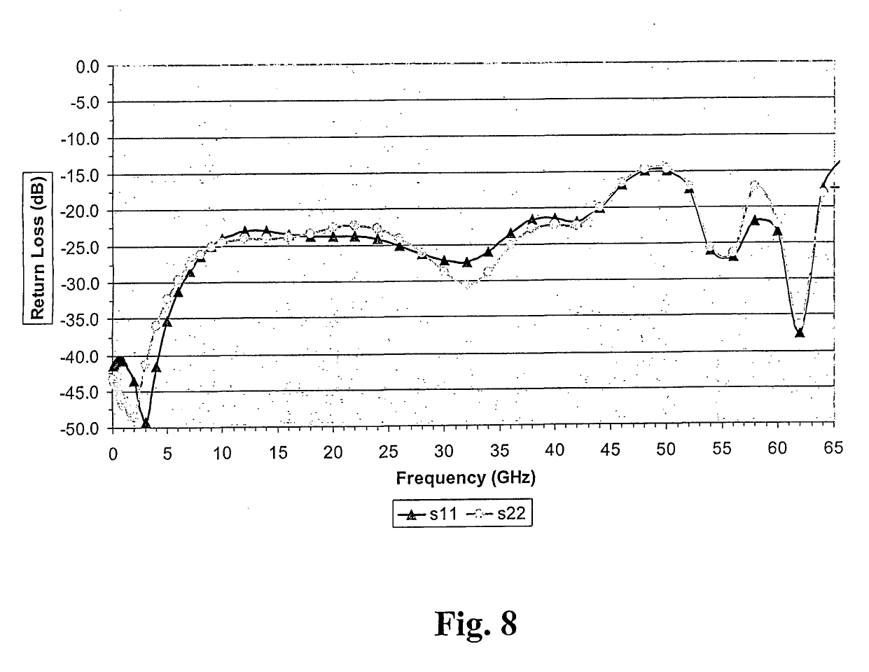

FIG. 8 shows a graph depicting the return loss (dB) versus frequency (GHz) for chip-to-chip connection through a plug and socket apparatus, according to the present invention.

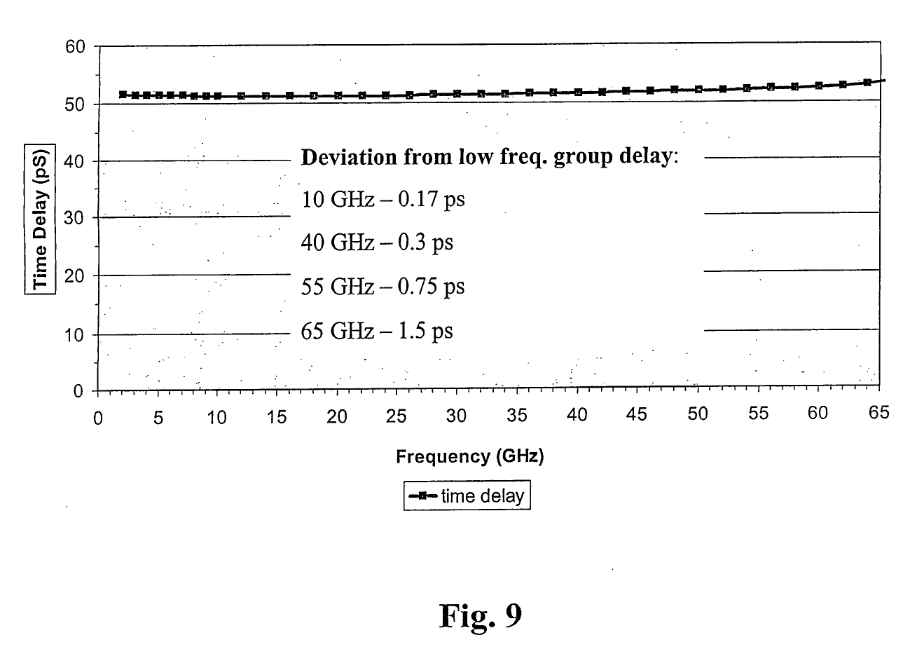

FIG. 9 shows a graph depicting the time delay (pS) versus the frequency (GHz) for a plug and socket transition (or package to package transition) in a plug and socket packaging system, according to the present invention. The group delay deviation is nearly zero across all frequencies due to the design of the present invention. This upper frequency limit can be scaled to higher frequencies exceeding 100 GHz using this technology, by shrinking down all dimensions proportionally.

Another advantage of the present invention is that, because the packaging system is made out of silicon, the packaging system according to the present invention has a high thermal conductivity. The thermal conductivity of the silicon packaging system is equivalent to the thermal conductivity of a packaging system made of metal. One problem with known optoelectronic modules is the requirement for high thermal conductivity in the packaging system. For example, heating of the package can cause movement of fiber alignment due to thermal expansion of dissimilar materials (for example, epoxy or solder holding fiber in place, and PIN diode material, etc.). In known packaging systems, a separate heat sink (for example, an additional component to select and attach during assembly) is located in the package to help with problems of thermal conductivity.

The packaging system according to the present invention solves these problems. First, by holding the optical fiber in a V-groove plug and socket alignment, the thermal drift of alignment is minimized. Second, the entire optoelectronic module is manufactured out of a base of silicon so it reduces the number of different materials making up the module; thus, by forming more components out of a single material, such as silicon, misalignment, which results from the use of different materials that expand at different rates with temperature variations, can be minimized or eliminated. Third, because the silicon package is functioning both as a package and as a heat sink, the high thermal conductivity of silicon maintains the overall package at a lower operating temperature for better thermal stability, provides for longer operating lifetimes, and provides a less complicated assembly.

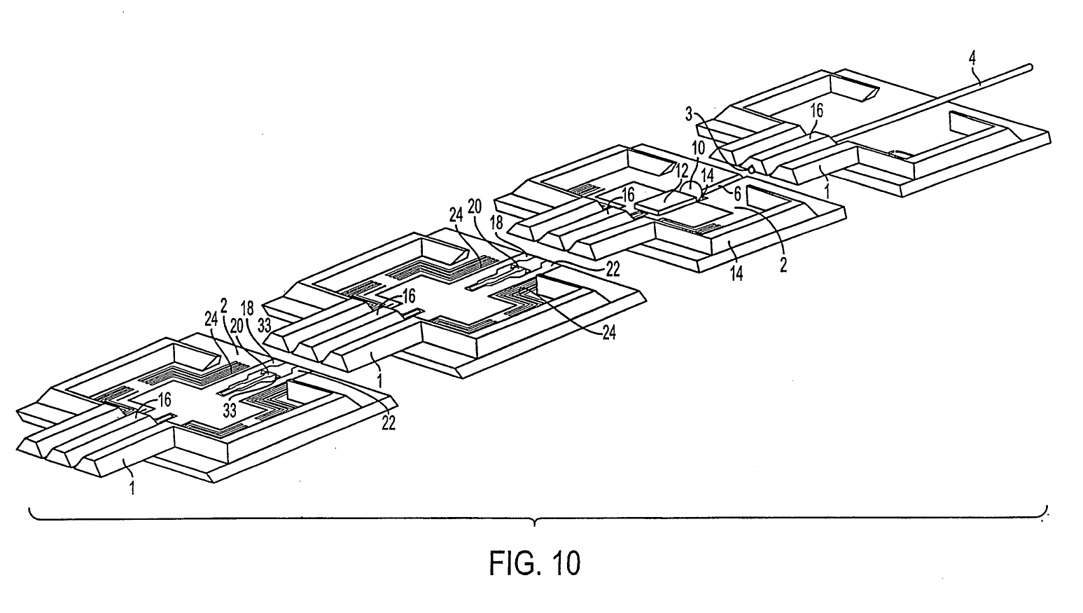

Moreover, optoelectronic converter modules, and systems based on these modules, can be manufactured according to the present invention. For example, FIG. 10 depicts a system having a first optical fiber module 40 with passive V-groove alignment means 3 to provide an optical fiber output, a second optical fiber module 42 with a ball lens 10 and PIN photodetector 12 to provide an optical fiber input and electrical output, and a third module 44 having a millimeter wave transimpedance amplifier. The first optical fiber module 40 is plugged into the second optical fiber module 42. The second optical fiber module 42 is then plugged into a third module 44 to form a system of modules. In addition, the third module 44 can be plugged into a fourth module, and so on. Any number of modules can be assembled to form a system according to the present invention. Further, other variations or combinations of the present invention are possible, for example, the transimpedance amplifier can be integrated into the PIN photodetector 12 and ball lens 10 module so that the same system can be formed using only two modules, instead of three modules.

1. An optical or optoelectronic connection apparatus comprising:
a first package of micromachined material having at least one male connection component;
a second package of micromachined material having at least one female component;
wherein said first package is configured to mate with said second package,
wherein a surface of said male component has a first V-groove,
wherein a surface of said female component has a second V-groove,
wherein said first V-groove is configured to align with said second V-groove when said first package and said second package mate, and
a first optical fiber disposed in said first V-groove and said second V-groove.

2. The optical or optoelectronic connection apparatus according to claim 1, further comprising:
a second optical fiber, wherein said second fiber is disposed in said second V-groove, whereby said first optical fiber is passively aligned with said second optical fiber by said first V-groove and said second V-groove to form a fiber butt joint.

3. The optical or optoelectronic connection apparatus according to claim 1, further comprising:
a photodetector disposed on a surface of said second package, whereby said first optical fiber is passively aligned with said photodetector by said first V-groove and said second V-groove to focus an optical signal from said first optical fiber on said photodetector.

4. The optical or optoelectronic connection apparatus according to claim 2, further comprising:
a ball lens disposed on said surface of said second package between said first optical fiber and said second optical fiber, whereby said first optical fiber and said second optical fiber are passively aligned with said ball lens by said first V-groove and said second V-groove.

5. The optical or optoelectronic connection apparatus according to claim 4, further comprising:
a cavity in said surface of said second package, said cavity disposed between said first optical fiber and said second optical fiber, wherein said ball lens is disposed in said cavity.

6. The optical or optoelectronic connection apparatus according to claim 5, wherein said cavity is a predetermined size based on a dimension of said ball lens, thereby aligning said ball lens with said first optical fiber and said second optical fiber to focus an optical signal from said first optical fiber to said second optical fiber.

7. The optical or optoelectronic connection apparatus according to claim 3, further comprising:
a ball lens disposed on said surface of said second package between said photodetector and said first optical fiber, whereby said first optical fiber is passively aligned with said ball lens by said first V-groove and said second V-groove.

8. The optical or optoelectronic connection apparatus according to claim 7, further comprising:
a cavity in said surface of said second package, said cavity disposed between said photodetector and said first optical fiber, wherein said ball lens is disposed in said cavity.

9. The optical or optoelectronic connection apparatus according to claim 8, wherein said cavity is a predetermined size based on a dimension of said ball lens, thereby aligning said ball lens with said first optical fiber and said photodetector to focus an optical signal from said first optical fiber on said photodetector.

10. The optical or optoelectronic connection apparatus according to claim 1, wherein said first V-groove and said second V-groove form a four-sided tube for encapsulating said first optical fiber.

11. The optical or optoelectronic connection apparatus according to claim 1, wherein said first package and said second package are individually hermetically sealed for environmental protection.

12. A packaging system for optical and optoelectronic devices, comprising:
a first package of micromachined material having at least one male connection component; and
a second package of micromachined material having at least one female component;
wherein said first package is configured to mate with said second package, and
wherein at least one surface of said male component or said female component has at least one V-groove.

13. The packaging system for optical and optoelectronic devices according to claim 12, wherein a surface of said male component has a first V-groove and a surface of said female component has a second V-groove,
wherein said first V-groove is configured to align with said second V-groove when said first package and said second package mate.

14. The packaging system for optical and optoelectronic devices according to claim 13, further comprising:
a first optical fiber disposed in said first V-groove and said second V-groove.

15. The packaging system for optical and optoelectronic devices according to claim 14, further comprising:
a second optical fiber, wherein said second fiber is disposed in said second V-groove, whereby said first optical fiber is passively aligned with said second optical fiber by said first V-groove and said second V-groove to form a fiber butt joint.

16. The packaging system for optical and optoelectronic devices according to claim 14, further comprising:
a photodetector disposed on a surface of said second package, whereby said first optical fiber is passively aligned with said photodetector by said first V-groove and said second V-groove.

17. The packaging system for optical and optoelectronic devices according to claim 16, further comprising:
a ball lens disposed on said surface of said second package between said photodetector and said first optical fiber, whereby said first optical fiber is passively aligned with said ball lens by said first V-groove and said second V-groove.

18. The packaging system for optical and optoelectronic devices according to claim 17, further comprising:
a cavity in said surface of said second package, said cavity disposed between said photodetector and said first optical fiber,
wherein said ball lens is disposed in said cavity.

19. The packaging system for optical and optoelectronic devices according to claim 18, wherein said cavity is a predetermined size based on a dimension of said ball lens, thereby aligning said ball lens with said first optical fiber and said photodetector to focus an optical signal from said first optical fiber on a sensor of said photodetector.

20. The packaging system for optical and optoelectronic devices according to claim 12, wherein said first package and said second package are individually hermetically sealed for environmental protection.

21. The packaging system for optical and optoelectronic devices according to claim 12, further comprising:
a first conductor line on said surface of said male component; and
a second conductor line on said surface of said female component, wherein said first conductor and said second conductor are in electrical contact with each other when said first package mates with said second package.

22. The packaging system for optical and optoelectronic devices according to claim 12, wherein an outside surface of said male component and said female component has a metal shield.

23. The packaging system for optical and optoelectronic devices according to claim 21, wherein said first conductor line and said second conductor line comprise RF lines.

24. The packaging system for optical and optoelectronic devices according to claim 21, wherein said first conductor line and said second conductor line comprise DC bias lines.

25. The packaging system for optical and optoelectronic devices according to claim 12, wherein said male component comprises a plurality of plug sections.

26. The packaging system for optical and optoelectronic devices according to claim 12, wherein said female component comprises a plurality of socket sections.

27. The packaging system for optical and optoelectronic devices according to claim 12, wherein said at least one V-groove on a surface of said male component or said female component is a predetermined size to create an air gap within said apparatus.

28. The packaging system for optical and optoelectronic devices according to claim 12, further comprising a plurality of V-grooves on said surface of said female component or said male component, whereby said V-grooves create a plurality of air gaps within said apparatus.

29. An optical or optoelectronic connection apparatus comprising:
a first package of micromachined material having at least one male connection component;
a second package of micromachined material having at least one female component;
a first optical fiber; and
a second optical fiber,
wherein said first package is configured to mate with said second package,
wherein a surface of said male component has a first V-groove designed to accept said first optical fiber,
wherein a surface of said female component has a second V-groove designed to accept said first optical fiber and said second optical fiber,
wherein said first V-groove is configured to align with said second V-groove when said first package and said second package mate, thereby passively aligning said first optical fiber with said second optical fiber to form a fiber butt joint.

30. A packaging system for optical and optoelectronic devices, comprising:
a first package of micromachined material having at least one male connection component;
a second package of micromachined material having at least one female component;
a first optical fiber; and
a photodetector,
wherein said first package is configured to mate with said second package,
wherein a surface of said male component has a first V-groove designed to accept said first optical fiber,
wherein a surface of said female component has a second V-groove designed to accept said first optical fiber,
wherein said first V-groove is configured to align with said second V-groove when the first package and second package mate, thereby passively aligning the first optical fiber with said photodetector to focus an optical signal from said first optical fiber on said photodetector.

31. A packaging system for optical and optoelectronic devices, comprising:
a first package of micromachined material having at least one male connection component; and
a second package of micromachined material having at least one female component;
wherein said first package is configured to mate with said second package, and
wherein an insertion loss of said packaging system ranges from 0.0 dB to −0.9 dB for frequencies between 0 and 65 GHz.

32. A packaging system for optical and optoelectronic devices, comprising:
a first package of micromachined material having at least one male connection component; and
a second package of micromachined material having at least one female component;
wherein said first package is configured to mate with said second package, and
wherein a time delay deviation of said packaging system ranges from 0.0 pS to 1.5 pS for frequencies between 0 and 65 GHz.

33. The packaging system for optical and optoelectronic devices according to claim 1, wherein said first package of micromachined material and said second package of micromachined material are silicon.

34. The packaging system for optical and optoelectronic devices according to claim 12, wherein said first package of micromachined material and said second package of micromachined material are silicon.

35. The packaging system for optical and optoelectronic devices according to claim 29, wherein said first package of micromachined material and said second package of micromachined material are silicon.

36. The packaging system for optical and optoelectronic devices according to claim 30, wherein said first package of micromachined material and said second package of micromachined material are silicon.

37. The packaging system for optical and optoelectronic devices according to claim 31, wherein said first package of micromachined material and said second package of micromachined material are silicon.

38. The packaging system for optical and optoelectronic devices according to claim 32, wherein said first package of micromachined material and said second package of micromachined material are silicon.

39. The packaging system for optical and optoelectronic devices according to claim 2, further comprising:
a cylindrical lens disposed on said surface of said second package between said first optical fiber and said second optical fiber, whereby said first optical fiber and said second optical fiber are passively aligned with said cylindrical lens by said first V-groove and said second V-groove.

40. The packaging system for optical and optoelectronic devices according to claim 29, wherein a plurality of packaging systems are stacked to form connectable and reconnectable three-dimensional plug and socket optical fiber arrays.

41. The packaging system for optical and optoelectronic devices according to claim 30, wherein a plurality of packaging systems are stacked to form connectable and reconnectable three-dimensional plug and socket optical fiber to electrical converter arrays.

42. The packaging system for optical and optoelectronic devices according to claim 1, wherein said first package and said second package can be mated and unmated, whereby either of said first and second package can be repaired or replaced.

43. The packaging system for optical and optoelectronic devices according to claim 29, wherein said first package and said second package can be mated and unmated, whereby either of said first and second package can be repaired or replaced.

44. The packaging system for optical and optoelectronic devices according to claim 30, wherein said first package and said second package can be mated and unmated, whereby either of said first and second package can be repaired or replaced.

45. The packaging system for optical and optoelectronic devices according to claim 1, further comprising:
a butterfly package for hermetically sealing a device within said butterfly package;
wherein said packaging system for optical and optoelectronic devices is mounted within said butterfly package, whereby modifications to said device within said butterfly package is performed by replacing either or both of said first package or said second package.

46. The packaging system for optical and optoelectronic devices according to claim 12, further comprising:
a butterfly package for hermetically sealing a device within said butterfly package;
wherein said packaging system for optical and optoelectronic devices is mounted within said butterfly package, whereby modifications to said device within said butterfly package is performed by replacing either or both of said first package or said second package.

47. The packaging system for optical and optoelectronic devices according to claim 29, further comprising:
a butterfly package for hermetically sealing a device within said butterfly package;
wherein said packaging system for optical and optoelectronic devices is mounted within said butterfly package, whereby modifications to said device within said butterfly package is performed by replacing either or both of said first package or said second package.

48. The packaging system for optical and optoelectronic devices according to claim 30, further comprising:
a butterfly package for hermetically sealing a device within said butterfly package;
wherein said packaging system for optical and optoelectronic devices is mounted within said butterfly package, whereby modifications to said device within said butterfly package is performed by replacing either or both of said first package or said second package.
